(19) United States
(12) Patent Application Publication
(10) Pub. No.: US 2002/0130070 A1
(43) Pub. Date: Sep. 19, 2002

(54) Drain filter pad and system

(76) Inventor: Donald A. Roesner, Sanger, CA (US)

Correspondence Address: Richard A. Ryan, RYAN & ENGNATH, 8469 N.Millbrook, Suite 104, Fresno, CA, 93720, US

(21) Appl. No.: 09/812,479

(22) Filed: Mar. 19, 2001

(51) Int. Cl. C02F 1/00; B01D 35/02

(52) U.S. Cl. 210/163; 210/490

(57) ABSTRACT

A drain filter pad and system for the same for preventing silt, debris and contaminants carried by storm and other runoff water from entering a storm drainage system. The filter pad comprises a porous outer shell with a permeable pad enclosed in the outer shell for attachment to the upper surface of the drain inlet grate. The outer shell is a synthetic mesh that blocks debris and larger contaminants from the drainage system. The permeable pad is an organic material that blocks silt and absorbs contaminants. The outer shell has an opening at one end for replacing the permeable pad. A closure mechanism closes the permeable pad in the outer shell. Fasteners securely attach the filter pad to the inlet grate without requiring removal of the grate. One such fastener passes through holes in the filter pad to interact with the underside of the grate.

### BACKGROUND OF THE INVENTION

1. Field of the Invention

The field of the present invention relates generally to filter devices used for filtering silt, debris and contaminants out of flowing water. More specifically, the present invention relates to drain filters and systems that prevent silt, debris and contaminants carried in runoff water from entering a storm drainage system. Even more specifically, the present invention relates to such drain filters and systems that are configured to attach to a storm drain inlet and which utilize replaceable filter pad inserts to filter runoff water.

2. Background

Most towns, cities, counties and other municipalities utilize storm drainage systems that include a system of collecting running water in the streets and delivering that water to a storage basin, water treatment facility, river, lake, ocean or other location where the running water can be either put to use or safely handled to avoid flooding of homes and businesses. The source of the water can be runoff from rain storms, which typically deliver the largest quantity of water in a given time period that must be handled, or runoff from domestic, industrial and agricultural uses, including uses such as lawn watering, car washing, building cleaning and the like. The typical storm drainage system transfers the water from where it collects (i.e., parking lots or streets) through an underground storm drain piping system comprising a series of interconnected pipes. The running water enters the storm drainage system through drain inlets that open into the underground piping system. The typical storm drain inlet is a grate that comprises a series of metal bars or plates formed into an open configuration that allows water to pass through the grate yet which is capable of supporting automobiles and other vehicles that pass over the grate.

The water that runs off as a result of storms or domestic and industrial uses carries with it silt (i.e., dirt, soil, sediment and the like) and debris that is at the location, such as a home or business, from where the water initiates or that is located (usually unintentionally) in the street along which the water flows before entering the storm drain system. Most of the silt in runoff water typically comes from non-vegetative areas or areas where the vegetation has been disturbed. This is particularly the case in construction projects that require the land to be graded or otherwise disturbed. A storm or other release of water may cause runoff to flow across the construction site and pickup significant amounts of silt or debris. Debris may include leaves, sticks and other “natural” materials. Unfortunately, some of the debris that is carried by runoff water is trash and other waste materials. The runoff water also collects and transports with it a variety of contaminants that are found at the home, business or in the street. Contaminants found in runoff water includes various petroleum materials, such as oil, grease and gasoline, which spill or drip from automobiles and other vehicles. The runoff water contaminants also include pesticides, herbicides, insecticides and other chemicals which are used in the yards of homes, on the vegetation around businesses or on agricultural properties. Chemicals and soaps used in the cleaning of the exterior of homes, businesses and vehicles are contaminants that also end up in the runoff water. Most of the contaminants are known to be harmful to human, animal and/or plant life.

The silt, debris and contaminants flow through the storm drainage system and end up in the storage basin or river, lake, ocean or other body of water where the storm drainage system terminates. It is well known that the contaminants and waste materials carried in the runoff water are harmful to fish, animal and plant life that lives in or around the rivers, lakes and oceans where the drainage systems terminate. Lesser known, but equally as harmful, is the harm caused by runoff water that terminates in storage basins and runoff water that carries excessive amounts of silt and similar “natural” debris. Although most storage basins appear to be independent of any rivers, lakes or oceans that are useful to humans and animals, they in fact usually are not. Most storage basins hydrologically connect to underground water aquifers that are used for domestic, agricultural or industrial purposes or which flow to rivers, lakes and oceans. In addition, many birds and animals utilize storage basins, even if they only intermittently contain water. Silt carried by runoff water is also harmful to any of the bodies of water where the storm drainage system terminates. Excessive silt in a river, lake or ocean inlet can negatively impact the ability of plants, animals and fish to utilize the water body for life or a food supply. Water for domestic and industrial uses taken from a body of water having excessive silt requires significantly more treatment, resulting in higher costs. Silt in a storage basin can harm animal or plant life around the basin and result in a “plugging” of the bottom of the basin, thereby limiting or preventing the flow of water into an underground water supply, which reduces recharge of the groundwater aquifer and increases the amount of time necessary to drain the storage basin so that it can be ready to receive more runoff water.

Storm water runoff is thought to be the largest source of water pollution. Due to the harm caused by the propensity of runoff waters to contain silt, debris and contaminants, federal and state governments have promulgated laws and regulations that address the quality of runoff water. For instance, the United States Environmental Protection Agency has issued regulations and guidelines under the Clean Water Act addressing storm water runoff. The fact that contamination from storm water runoff is a nonpoint source of pollution, it is difficult to control at the source level. As a result, federal and state governments regulate the discharge of the runoff into a body of water, where the quality of the water can be measured. The various laws and regulations take a “carrot and stick” approach to solving the storm water runoff quality problem. For the carrot, the government offers technical assistance and financial incentives in the form of grant monies. For the stick, the government withholds development funds, such as highway funds, for failing to meet the objectives.

A low technology solution to the runoff problem has been to place bales of hay around the drain inlet so that water will seep through the bales while debris and larger contaminants are stopped. Several filter devices have been developed to prevent silt, debris and contaminants in runoff water from entering a storm drainage system through the drain inlet. One such filter is set forth in U.S. Pat. No. 6,010,622 to Chinn. This patent discloses an envelope made of a porous material that has an opening for receiving a grate therein. The grate is placed in the envelope and the envelope is positioned in its customary place over the drain inlet. The envelope allows water to pass therethrough while preventing unwanted material from entering the storm drain. Another filter is disclosed in U.S. Pat. No. 5,725,782, also to Chinn. This filter discloses placing the grate in the filter envelope and then placing the envelope into a catch basin to filter the runoff water. U.S. Pat. No. 5,632,888 discloses an environmental filter system configured to substantially cover the opening of a curb inlet to allow runoff water but not debris to pass into the inlet. The filter comprises a permeable body portion enclosed with an elongated porous material. The inventions described in the above-identified patents are believed to be incorporated into products available from Dandy Products, Inc. out of Grove City, Ohio. U.S. Pat. No. 5,372,714 to Logue discloses a storm sewer catch basin and filter comprised of a filter bag that is disposed under the grate to filter out solids that enter the inlet. Elongated lift flaps at the top of the filter bag hold the filter in place between the grate and the catch basin. The invention described by 1:0 this patent is believed to be incorporated into a product available from ACF Environmental out of Richmond, Va. U.S. Pat. No. 6,086,758 to Schilling, et al., discloses a storm drainage liner comprised of a filter inside a basket which is suspended from a frame positioned between the storm drain inlet and the drain grate. The invention described by this patent is believed to be incorporated into a product available from Pactec, Inc. out of Clinton, La. U.S. Pat. No. 5,720,574 to Barella discloses a contaminant absorbing drainage trough that comprises a solid trough structure which contains replaceable filter liner that allows water to pass through while retaining contaminants. This patent has been assigned to KriStar Enterprises out of Santa Rosa, Calif. Kristar Enterprises also sell products that utilize catch basins having inserts to filter out materials from runoff water. Zymark, Inc. out of Portland, Oreg. manufactures a catch basin with filter insert device that also utilizes a catch basin and a filter bag that is held in place by the grate positioned over the inlet.

Although the aforementioned patents and products are designed and configured to filter silt, debris and/or contaminants out of runoff water so as to prevent those unwanted materials from entering the storm drainage system through the drain inlet, they each have the drawback that they require the removal, handling and replacement of the inlet grate in order to accomplish their objectives. As is well known, the inlet grates are very heavy, typically requiring more than one person or lifting equipment to safely move. In addition, the accumulation of silt and other materials in the filter medium underneath the inlet grate makes removal of the spent filter and filtered materials difficult. It can be appreciated, therefore, that what is needed is a drain filter suitable for use with drain inlets to prevent entry of silt, debris and contaminants into a storm drainage system that does not require the removal, handling and replacement of the inlet grate. The drain filter should be suitable for attachment to the inlet grate to prevent movement of the filter during runoff flows and include a removable interior filter portion to allow replacement of the filter.

### SUMMARY OF THE INVENTION

The drain filter pad and system of the present invention solves the problems and provides the benefits identified above. That is to say, the drain filter pad and system of the present invention provides a drain filter that is adaptable for a variety of inlet grates and suitable for installation thereon so as to prevent the entry of silt, debris and contaminants into a storm drainage system. The drain filter pad of the present invention is easily and quickly installed on drainage system inlet grates, as it does not require any modifications to or removal of the inlet grate. In the preferred embodiment of the present invention, the drain filter pad includes a removable filter portion that can be removed for cleaning or replacement from the filter pad when it becomes saturated with silt, debris and/or contaminants.

In the primary embodiment of the present invention, the drain filter pad is used in combination with a drain inlet covered by an inlet grate having a top surface, a bottom surface and a plurality of openings in the grate. The drain filter pad comprises a porous outer shell, a permeable pad disposed in the outer shell and one or more holes through the outer shell. In the preferred embodiment, the outer shell is made from a synthetic material that is resistant to ultraviolet light damage, such as commercial grade polypropylene mesh. Also in the preferred embodiment, the outer shell has a opening therein to receive or remove the permeable pad and a closure mechanism (such as Velcro®) at the shell opening to close the permeable pad inside the outer shell. In the preferred embodiment, the permeable pad can be one or more pads that are made of an organic material, such as aspen wood fibers (known as excelsior). The holes should be configured to receive a fastener to secure the drain filter pad to the top surface of the inlet grate. To protect the holes and the outer shell of the filter pad, the preferred embodiment utilizes grommets at the hole to facilitate entry of the bolts through the filter pad. The preferred fastener, comprising a bolt and molly combination, is sized and configured to pass through the openings in the inlet grate and interact with the bottom surface of the inlet grate. With the drain filter pad attached to the inlet grate, any runoff water will flow through the porous outer shell of the drain filter pad and the permeable pad therein to remove any silt, debris and contaminants that may be in the runoff water. Larger debris and contaminants will not pass through the outer shell. Silt and contaminants will be absorbed by the permeable pad.

The drain filter system of the present invention for filtering runoff water comprises a drain inlet covered by an inlet grate having a top surface, a bottom surface and a plurality of openings with a drain filter pad having a porous outer shell, a permeable pad disposed in the outer shell and one or more holes through the outer shell secured to the top surface of the inlet grate with one or more fasteners through the filter pad. As with the drain filter pad described above, the system includes the ability to open and close the outer shell so the permeable pad can be removed and replaced when it becomes saturated with contaminants or the like. The fastener interacts with the bottom surface of the inlet grate to securely hold the drain filter pad to the upper surface of the inlet grate. The preferred outer shell is a synthetic mesh material that is resistant to ultraviolet light damage, such as polypropylene mesh, and the preferred permeable pad is made out of an organic material such as excelsior.

Accordingly, the primary objective of the present invention is to provide a drain filter pad and system that is secured to the top surface of a storm drain inlet grate for blocking the entry of silt, debris and contaminants carried by runoff water into a storm drainage system.

It is also an important objective of the present invention to provide a drain filter pad and system that utilizes a porous outer shell and a permeable pad disposed in the outer shell such that runoff water can pass through the outer shell and into a drainage inlet but any silt, debris or contaminants in the runoff water does not enter the drainage inlet.

It is also an important objective of the present invention to provide a drain filter pad and system that can be securely attached to the top surface of an inlet grate and which comprises an outer shell having an opening thereon for receiving and removing a permeable pad therein and a closure mechanism for closing the permeable pad inside the outer shell.

It is also an objective of the present invention to provide a drain filter pad and system that securely attaches to but does not require the moving of the inlet grate of a storm drainage system so as to block the entry of silt, debris and contaminants into the storm drain inlet.

The above and other objectives of the present invention will be explained in greater detail by reference to the attached figures and the description of the preferred embodiment which follows. As set forth herein, the present invention resides in the novel features of form, construction, mode of operation and combination of elements presently described and understood by the claims.

### BRIEF DESCRIPTION OF THE DRAWINGS

In the drawings which illustrate the best modes presently contemplated for carrying out the present invention:

FIG. 1 is an exploded view of the drain filter pad system of the preferred embodiment of the present invention;

FIG. 2 is a side view of the drain filter pad and system of the preferred embodiment of the present invention; and

FIG. 3 is a perspective view of a drain filter pad of the present invention in place on a inlet grate.

### DETAILED DESCRIPTION OF THE PREFERRED EMBODIMENTS

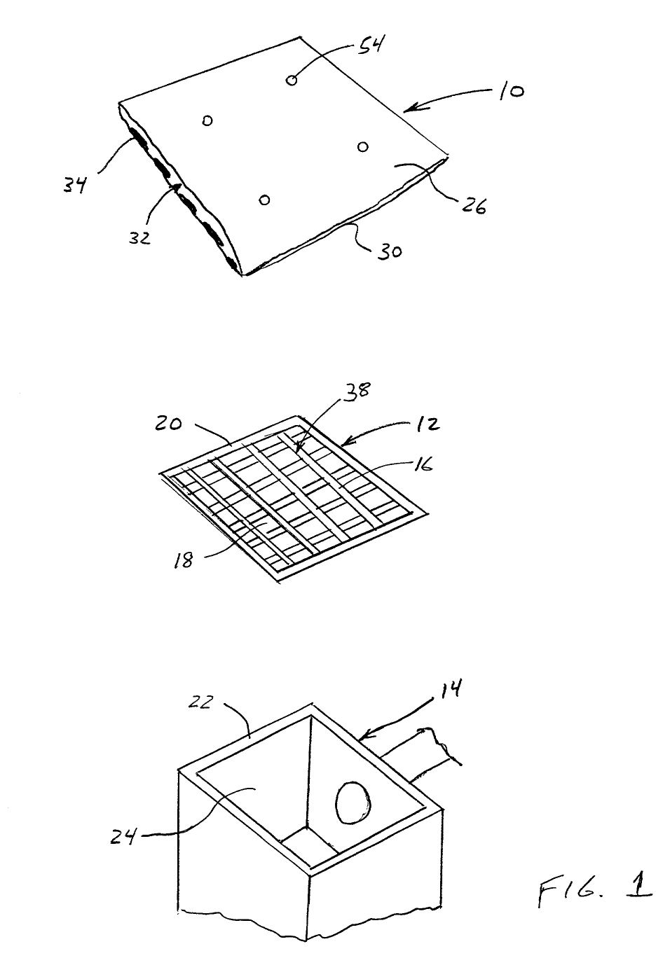

With reference to the figures where like elements have been given like numerical designations to facilitate the reader's understanding of the present invention, and particularly with reference to the embodiment of the present invention illustrated in FIGS. 1 through 3, the preferred embodiment of the present invention is set forth below. As shown in FIGS. 1 and 3, the drain filter pad 10 is sized and configured to entirely cover and block the inlet grate 12 which sits in inlet 14 to a drainage system for carrying away runoff water, such as water that results from a storm, to a storage basin, river, lake or ocean. The typical inlet grate 12 is made out of metal and comprises a series of metal dividers 16, such as rods, bars or plates, that form a plurality of openings 18 in grate 12. The outer edge 20 of grate 12 is sized and configured to rest on inset ledge 22 around the drainage opening 24 of inlet 14. Generally, grate 12 is made of heavy gage metal which results in a heavy grate 12 that will securely rest in inlet 14 due to the force of gravity alone. Once in place in inlet 14, the top of grate 12 is at approximately street level and is strong enough to support automobiles and other vehicles that may drive over grate 12. Runoff water that collects in the streets, driveways or other areas flows through the openings 18 in grate 12 to the drainage opening 24 so as to be carried by the drainage system. The openings 18 in grate 12 formed by dividers 16 are sized so as to permit easy flow of runoff water therethrough while preventing larger sized debris from entering and clogging the drainage system. Prior to the current environmental concerns with silt, debris and contaminants in runoff water flowing to storage basins, rivers or other bodies of water, only the larger size debris was kept out of the drainage system by grate 12. Silt and contaminants, as well as smaller debris, would merely flow through the openings 18 in grate 12. The presently available devices for preventing silt, smaller debris and contaminants from affecting water supply sources require removal and replacement of the grate 12. Due to the weight of grate 12, this is typically not an easy task.

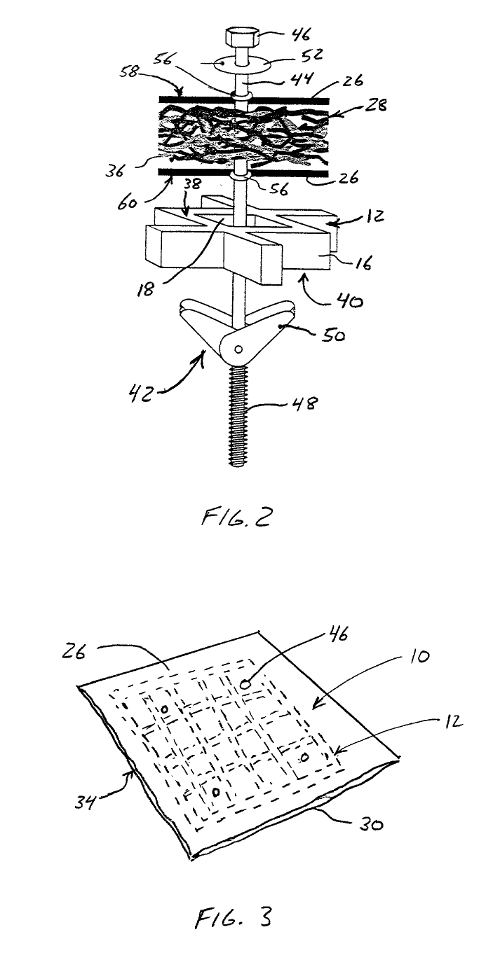

As shown in FIGS. 1 and 2, drain filter pad 10 has a porous outer shell 26 formed in a bag-type configuration that is sized to completely cover grate 12. Preferably, drain filter pad 10 will extend beyond (i.e., six to twelve inches) the outer edges 20 of grate 12 so as to ensure the entry into drainage opening 24 is blocked. The outer shell 26 encloses a permeable pad 28, described in more detail below, that is configured to absorb the small silt particles, debris and contaminants that are carried in runoff water. The outer shell 26 blocks the larger silt particles, debris and contaminants while allowing the runoff water to pass through the filter pad 10 and into the drainage opening 24. The outer shell 26 must be made out of porous material that is able to withstand exposure to sun, rain, snow and other conditions of nature that are expected of a material that is exposed to outdoor elements. In addition, the material and manufacturing of outer shell 26 should be such as to withstand being run over by automobiles and other vehicles without tearing or otherwise opening and potentially spreading the material for permeable pad 28 over the street. Although a variety of materials may be suitable for outer shell 26, many of the commonly available synthetic materials are known to be strong enough to contain pad 28 and withstand the rigors of outdoor use, including ultraviolet light exposure, which has a tendency to dry out and make materials brittle. A synthetic material that is commonly available for outer shell 26 is the commercial grade of ultraviolet stabilized polypropylene mesh.

In one configuration, outer shell 26 is made of woven polypropylene geotextile material having small mesh openings (not shown). The openings in outer shell 26 must be sized to contain the material from which pad 28 is made from (i.e., wood fibers or the like) in filter pad 10 without inhibiting the flow of water through filter pad 10 when in use. If the mesh openings are too large, pieces of wood fibers or other materials from which pad 28 is made would pass through pad 10 and into the drainage system, carrying with it any silt, debris or contaminants that were previously blocked by filter pad 10. The outer edges 30 of filter pad 10 are sealed with stitching to enclose pad 28 therein. Preferably, the stitching is made from a plastic material having ultraviolet light protection incorporated therein. A biodegradable material such as jute, cotton or other natural fibers may also be used for the stitching.

In the preferred embodiment, at least one of the edges 30 is left open to form a shell opening 32 for insertion and removal of pad 28 from outer shell 26. Shell opening 32 allows the user of filter pad 10 to remove the interior permeable pad 28 from filter pad 10 when it becomes saturated and is no longer able to be effective at absorbing silt, debris and/or contaminants. To prevent the pad 28 from inadvertently being displaced from outer shell 26 during use (i.e., heavy runoff), the preferred embodiment of the present invention should include a mechanism for closing shell opening 32. One such mechanism would be to extend the length of outer shell 26 at the edge 30 where shell opening 32 is located (i.e., similar to an elongated bag or envelope) so that the outer shell 26 material can be folded over under the filter pad 10 when it is secured to grate 12, thereby effectively closing shell opening so as to prevent the permeable pad 28 from inadvertently being displaced. The preferred closure mechanism, shown in FIG. 1, is one or more strips of hook and loop material (i.e., Velcro®) 34 at the outer edge 30 where shell opening 32 is located. The Velcro® strips 34 can be pulled apart to open shell opening 32 sufficiently for permeable pad 28 to be slid into outer shell 26. When it is necessary to remove and replace pad 28, the Velcro® strips 34 can be pulled apart again to open shell opening 32. As is well known in the art, other closure mechanisms, including snaps, buttons, zippers and the like can also be used to close shell opening sufficiently to prevent pad 28 from coming out of outer shell 26.

Permeable pad 28 can be made out of a variety of synthetic and natural materials. In the preferred embodiment, pad 28 is made into a mat form from a substantially uniformly distributed absorbent organic media, such as aspen wood fibers (known as excelsior), shown as 36 on FIG. 2, or other varieties of natural cellulosic materials, such as paper, wood products or coconut fibers. Excelsior 36 is preferred due to its superior qualities, including its availability, cost and ease of forming into wood fibers to create a mat for permeable pad 28 that has an open cellular structure providing a highly absorbent pad 28 that is able to retain more contaminants and other materials per square inch than many other materials. In the preferred embodiment, the excelsior wood fibers 36 are thinly cut into individual segments that enable them to be mechanically layered and oriented in a generally horizontal plane in a pad 28 of relatively uniform thickness and density. Typical dimensions of such individual segments are 0.042 inch width, 0.021 inch thickness and 18 inch length. As is known by those skilled in the art, a variety of sizes of the individual segments are available for the absorbent material. If the segments are too small, they will break easily and not stay together as a pad 28. If the segments are too large, the amount of surface area available for contact with the contaminants and the like may be substantially diminished, thereby reducing the retaining efficiency of pad 28. Inside outer shell 26 can be placed one or more permeable pads 28, depending on the amount of blocking desired and flow of water required. In one embodiment of the present invention, the inventor utilizes three separate pads 28 inside outer shell 26 to form filter pad 10. For high flow rates of runoff water, it may be necessary to utilize less pads 28 so as to reduce the density of filter pad 10 and allow more water to pass through filter pad 10 into drainage opening 24.

Although the filter pad 10 can be placed on top of grate 12 without any mechanism to secure pad 10 to grate 12, the light weight of pad 10 will generally result in unwanted movement of pad 10 off of grate 12. In the preferred embodiment a fastener is used to securely attach filter pad 10 to grate 12 so that the pad 10 is not washed away during periods of high runoff flow. Although a number of different fasteners could work with the present invention to securely attach pad 10 to the top surface 38 of grate 12, the preferred fastener is one that can attach the pad 10 to the grate 12 from above (i.e., not being necessary to lift pad 10 or grate 12 to install). The fastener can be of the type that secures the filter pad 10 to the top surface 38 of grate 12 by directly connecting to the top surface 38 by way of clamp or other fastener placed directly under pad 10 that clamps or connects to grate dividers 16. The fastener can also comprise one or more cords, ropes, wires or the like that are attached at one end to pad 10 and then the other end goes through opening 18 to either connect to pad 10, to itself or to the grate 12. In one embodiment, the preferred fastener, as shown in FIG. 2, is a bolt and molly fastener 42, which consists of a bolt 44, having head 46 at one end and a threaded end 48 at the opposite end, and molly connector 50. If desired, washer 52 can be used to prevent bolt head 46 damaging outer shell 26 during installation. Filter pad 10 includes one or more holes 54 (shown in FIG. 1) in outer shell 26 that are configured to accept bolt 44 therethrough. The bolt 44 passes through hole 54, outer shell 26 and pad 28. The molly 50 is attached to the threaded end 48 so that it may pass through opening 18 in grate 12 and then abut against the bottom surface 40 of grate 12. When bolt head 46 is tightened, the threaded end 48 of bolt 44 moves downward through molly 50, causing molly 50 to abut against bottom surface 40 of grate 12. Continued tightening of bolt 44 securely attaches pad 10 to grate 12. To prevent tearing damage to outer shell 26 of pad 10, a grommet 56 can be used at the holes 54 in outer shell 26. Bolt 44 passes through the grommet 56 on the upper surface 58 of outer shell 26, through pad 28 and then through the grommet 56 on the lower surface 60 of outer shell 26. In one configuration, as shown in FIG. 3, four fasteners are used to attach filter pad 10 to the upper surface 58 of grate 12. In an alternative configuration of the present invention, bolt 44 can be replaced with a J-hook or a multiple prong connector (neither is shown). The multiple prong connector can have one or more threaded bolt ends 48 for the molly connectors 50 to connect. In another configuration, a plate, one or more strips of metal, or other types of devices can be utilized to interconnect the bolts 44 on the upper surface 58 of pad 10 so as to press downward on filter pad 10 and more securely hold filter pad 10 to grate 12. Such a configuration would only be necessary for extremely high runoff water flow rates.

In use, the preferred filter pad 10 is formed by opening outer shell 26 and then placing one or more (depending on the desired blocking and runoff flow-through characteristics desired) permeable pads 28 inside outer shell 26. The Velcro® closure mechanism strips 34 are pressed together to close pad 28 inside outer shell 26. One or more bolts 44 are inserted through an equal number of grommets 56 (around holes 54) on the upper surface 58 of outer shell 26 and then pushed through pad 28 to a corresponding grommet 56 (around a hole 54) on the lower surface 60 of outer shell 26. The molly connector 50 is threaded on the threaded end 48 of bolt 44. After all the bolts 44 being used are installed through filter pad 10, filter pad 10 is placed on the top surface 38 of grate 12 such that the molly connectors 50 are pushed through openings 18 in grate 12. Each bolt 44 is then tightened to bring the molly connector 50 up against the bottom surface 40 of grate 12 to securely attach filter pad 10 to grate 12. During storm or other water runoff, filter pad 10 will block entry of silt, debris and contaminants into drainage opening 24, thereby keeping these materials out of the drainage system and the runoff water's final destination. The outer shell 26 will filter out the larger debris and contaminants. The permeable pad 28 will filter and absorb the silt and smaller contaminants (i.e. petroleum products). When it is necessary to replace pad 10 (i.e., due to being saturated with contaminants), the user backs off each of the bolts 44 to cause the molly connectors to become disengaged from bolt 44 so that pad 10 may become free of grate 12. The Velcro® enclosure 34 is opened and the old pad or pads 10 are removed and replaced with a new pad or pads 10. The outer shell 26 is re-closed and the pad is re-installed on grate 12. Outer shell 26 can be cleaned during replacement of the permeable pad 28 or replaced if torn or otherwise damaged from use.

In an alternative embodiment, outer shell 26 can be secured to pad 28 with rows of stitching spaced across pad 28 as preferred by the manufacturer. For instance, the stitching rows can be spaced apart approximately every two inches. The stitching would run the entire length of outer shell 26 along edge 30. In this configuration, the stitching would penetrate pad 28 to stabilize and unitize the wood fibers 36 in pad 28, thereby providing a more compact and single unit. However, in this configuration, the entire filter pad 10 would have to be replaced when pad 28 becomes saturated with contaminants.

In other alternative embodiments, the outer shell 26 can be coated with materials to improve its durability from wear or exposure to ultraviolet light. Permeable pad 28 can incorporate various additives that can interact with known pollutants so as to neutralize those pollutants for improved filtration of the runoff water. If desired, outer shell 26 can be made into different colors so as to indicate what purpose the filter pad 10 is to be used (i.e., silt only, chemical blocking, etc.) and/or for improved visibility so as to reduce vehicle traffic over filter pad 10.

While there is shown and described herein certain specific alternative forms of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to the dimensional relationships set forth herein and modifications in assembly, materials, size, shape, and use.

What is claimed is:

1. A drain filter pad in combination with a drain inlet covered by an inlet grate having a top surface, a bottom surface and a plurality of openings therein, said drain filter pad comprising:
a porous outer shell;
a permeable pad disposed in said outer shell; and
means for fastening said drain filter pad to said top surface of said inlet grate,
whereby when said drain filter pad is fastened to said inlet grate runoff water flows through said porous outer shell of said drain filter pad to allow said permeable pad to remove any silt, debris and contaminants that may be in said runoff water.

2. The drain filter pad of claim 1, wherein said outer shell is made from a synthetic material that is resistant to ultraviolet light damage.

3. The drain filter pad of claim 2, wherein said synthetic material is polypropylene.

4. The drain filter pad of claim 1, wherein said outer shell has a shell opening therein for receiving and removing said pad.

5. The drain filter pad of claim 4, wherein said outer shell further comprises closure means for closing said shell opening.

6. The drain filter pad of claim 1, wherein said permeable pad is made of an organic material.

7. The drain filter pad of claim 6, wherein said organic material is excelsior.

8. The drain filter pad of claim 1, wherein said drain filter pad comprises more than one of said permeable pads in said outer shell.

9. The drain filter pad of claim 1, wherein said drain filter pad comprises one or more holes through said outer shell, said one or more holes configured for receiving said fastening means therein to secure said drain filter pad to said top surface of said inlet grate.

10. The drain filter pad of claim 9 further comprising a grommet at each of said one or more holes in said outer shell.

11. The drain filter pad of claim 1, wherein said fastening means comprises a bolt and molly fastener.

12. The drain filter pad of claim 1, wherein said fastening means is sized and configured to connect pass through at least one of said openings in said inlet grate and interact with said bottom surface of said inlet grate.

13. A drain filter pad in combination with a drain inlet covered by an inlet grate having a top surface, a bottom surface and a plurality of openings therein, said drain filter pad comprising:
a porous outer shell comprising a synthetic material, said outer shell having a shell opening therein;
closure means on said outer shell for closing said shell opening;
a permeable pad disposed in said outer shell through said shell opening; and
means for fastening said drain filter pad to said top surface of said inlet grate.

14. The drain filter pad of claim 13, wherein said permeable pad is excelsior.

15. The drain filter pad of claim 13, wherein said drain filter pad comprises one or more holes through said outer shell, said one or more holes configured for receiving said fastening means therein to secure said drain filter pad to said top surface of said inlet grate.

16. The drain filter pad of claim 13, wherein said fastening means comprises a bolt and molly fastener.

17. The drain filter pad of claim 13, wherein said fastening means is sized and configured to connect pass through at least one of said openings in said inlet grate and interact with said bottom surface of said inlet grate.

18. A drain filter system for filtering runoff water, comprising:
a drain inlet covered by an inlet grate having a top surface, a bottom surface and a plurality of openings therein;
a drain filter pad having a porous outer shell and a permeable pad disposed in said outer shell; and
means for fastening said drain filter pad to said top surface of said inlet grate.

19. The drain filter system of claim 18, wherein said drain filter pad comprises one or more holes through said outer shell, said one or more holes configured for receiving said fastening means therein to secure said drain filter pad to said top surface of said inlet grate.

20. The drain filter system of claim 18, wherein said fastening means is sized and configured to pass through at least one of said openings in said inlet grate and interact with said bottom surface of said inlet grate.

21. The drain filter pad of claim 18, wherein said outer shell has a shell opening therein for receiving and removing said pad.

22. The drain filter pad of claim 21, wherein said outer shell further comprises closure means for closing said shell opening.

23. The drain filter pad of claim 18, wherein said outer shell is made from a synthetic mesh material and said permeable pad is made of an organic material.
